(19) United States
(12) Patent Application Publication
(10) Pub. No.: US 2026/0236358 A1
(43) Pub. Date: Aug. 13, 2026

(54) CROSS CLUSTER FAILOVER FRAMEWORK

(71) Applicant: Visa International Service Association, San Francisco, CA (US)

(72) Inventors: Yash DWIVEDI, Bangalore (IN); Rushil SHARMA, Bangalore (IN); Pragya PRIYADARSHINI, Bhagalpur (IN); Deepak VISWAKARMA, Karnataka (IN); Rameshkumar PERUMAL, Tamil Nadu (IN); Atul JAIN, Karnataka (IN); Asheesh GUPTA, Bangalore (IN)

(73) Assignee: Visa International Service Association, San Francisco, CA (US)

(21) Appl. No.: 19/154,152

(22) PCT Filed: Feb. 24, 2023
(86) PCT No.: PCT/US2023/063224

§ 371 Date: Aug. 6, 2025

(51) Int. Cl. G06F 11/20

(52) U.S. Cl. CPC G06F 11/2025; G06F 2201/805

(57) ABSTRACT

The present disclosure describes a cross cluster failover framework configured to switch a synchronous or asynchronous connection from a first cluster datacenter to a second cluster datacenter based on a health evaluation of the first and second cluster, on an application level, data stream level, or topic level basis. The connections between the first cluster and the consumer application, and second cluster and the consumer application are maintained throughout the failover framework allowing the failover process to be invisible on the consumer application side.

### TECHNICAL FIELD

The present disclosure relates to a cross cluster failover framework configured to switch a synchronous or asynchronous connection from a first cluster datacenter to a second cluster datacenter based on a health evaluation of the first and second cluster on a data stream category or topic level basis.

### SUMMARY

In one aspect, the present disclosure provides a distributed data processing system comprising: a cluster management server configured to communicate with a cluster system comprising a first server cluster and a second server cluster in geographically different regions, the cluster management server comprising a processor and a memory coupled to the processor, the memory storing thereon machine executable instructions that when executed cause the processor to: determine an initial health status of the first server cluster; establish a first push connection between a data source and the first server cluster based on a determination that the first server cluster is healthy; monitor data transmitting from the data source to the first server cluster, wherein the first server cluster publishes the data to a plurality of data stream categories corresponding to the data; determine a first cluster health status of the first server cluster for each of the plurality of data stream categories associated with the data source; determine a second cluster health status of the second server cluster for each of the plurality of data stream categories associated with the data source; determine the first server cluster is unhealthy for a first data stream category of the plurality of data stream categories associated with the data source; initiate a failover associated with the first data stream category for the data source, wherein the failover cause the processor to: establish a second push connection to the second server cluster based on a determination that the second server cluster is healthy for the first data stream category associated with the data source; and switch the data source from transmitting to the first server cluster to the second server cluster based on the determination that the first server cluster is unhealthy for the data source and the determination that the second server cluster is healthy for the data source.

In another aspect, the present disclosure provides a method for cross cluster failover management, the method comprising: determining, by a cluster management server, an initial first cluster health status of a first server cluster and an initial second cluster health status of a second server cluster; establishing, by the cluster management server, a push connection between a data source and the first server cluster based on determining that the initial first cluster health status of the first server cluster is healthy; monitoring, by the cluster management server, data transmitting from the data source to the first server cluster, wherein the first server cluster publishes the data to a plurality of data stream categories corresponding to the data; determining, by the cluster management server, a first cluster health status of the first server cluster for each of the plurality of data stream categories associated with the data source; determining, by the cluster management server, a second cluster health status of the second server cluster for each of the plurality of data stream categories associated with the data source; determining, by the cluster management server, the first server cluster is unhealthy for a first data stream category of the plurality of data stream categories associated with the data source; initiating, by the cluster management server, a failover associated with the first data stream category for the data source, wherein the failover is further comprising: establishing, by the cluster management server, a second push connection to the second server cluster based on a determination that the second server cluster is healthy for the first data stream category associated with the data source; switching, by the cluster management server, the data source from transmitting to the first server cluster to the second server cluster based on the determination that the first server cluster is unhealthy for the data source and the determination that the second server cluster is healthy for the data source; and maintaining, by the cluster management server, a first pull data connection between the first server cluster and a consumer application, and a second pull data connection between the second server cluster and the consumer application.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The cross cluster failover framework apparatuses, systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 shows a block diagram of a cross cluster failover framework of a cluster, comprising a local datacenter cluster and a remote datacenter cluster, and controlled by a cluster manager, according to at least one aspect of the present disclosure.

FIG. 2 is a block diagram of the cluster manager configured to continuously or periodically monitor the health of the remote cluster and local cluster, according to at least one aspect of the present disclosure.

FIG. 3 shows an example cluster configuration for nodes partitions and topics for a datacenter cluster in either the remote cluster or local cluster, according to at least one aspect of the present disclosure.

FIG. 4 shows a first example health check response evaluation by a cluster manager 106, for cluster configuration, according to at least one aspect of the present disclosure.

FIG. 5 shows a second example health check response evaluation by a cluster manager, for cluster configuration, according to at least one aspect of the present disclosure.

FIG. 6 shows a third example health check response evaluation by a cluster manager, for cluster configuration, according to at least one aspect of the present disclosure.

FIG. 7 is a flow diagram of a failover process, according to the cross cluster failover framework, from the local cluster to the remote cluster, according to at least one aspect of the present disclosure.

FIG. 8 is a block diagram of a cluster manager configured to buffer data from a data source, according to at least one aspect of the present disclosure.

FIG. 9 is a block diagram of a computer apparatus with data processing subsystems or components, according to at least one aspect of the present disclosure.

FIG. 10 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

An “interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some embodiments or aspects, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

A “user device” is an electronic device that may be transported and/or operated by a user. A user device may provide remote communication capabilities to a network. The user device may be configured to transmit and receive data or communications to and from other devices. In some embodiments or aspects, the user device may be portable. Examples of user devices may include mobile phones (e.g., smart phones, cellular phones, etc.), PDAs, portable media players, wearable electronic devices (e.g. smart watches, fitness bands, ankle bracelets, rings, earrings, etc.), electronic reader devices, and portable computing devices (e.g., laptops, netbooks, ultrabooks, etc.). Examples of user devices may also include automobiles with remote communication capabilities.

The present disclosures relates to a cluster computing platform for real-time data streams (e.g., Kafka, hazelcast, etc.). The cluster computing platform comprises a primary datacenter cluster (e.g. local cluster) that receives data streams, such as messages or data records, from a data source (e.g., producer application). The cluster computing platform publishes the data streams to data stream categories in the cluster so that it can be immediately accessible (e.g. consumed) by an application (e.g., consumer application). The cluster is configured to operate in redundant or parallel clusters with a primary cluster (e.g., local cluster) and a secondary datacenter cluster (e.g., remote cluster). The addition of the remote cluster may increase throughput capabilities for reading and writing of records from real-time data streams, and/or create a high availability data configuration for the real-time data streams. In various aspects, if the local cluster is deemed unhealthy, the data records (e.g. messages) from the data source will start to fail (after some retries) and the data source will not be able to write the data records to the local cluster until the local cluster is deemed healthy again. Rather than waiting for the local cluster to become healthy again, conventional failover frameworks switch over the data source to the remote cluster for all data stream categories (e.g. topics, maps, etc.). The conventional failover framework increase traffic overhead for real-time data streams and may create unnecessary failovers for data stream categories that write to healthy nodes within the cluster. The conventional failover framework ultimately creates unnecessary overhead for the remote cluster and increase in increased latency for otherwise healthy data streams.

The present disclosure describes a cross cluster failover framework (CCFF) to solve the above mentioned problem. The CCFF scheme adds the ability to write to the remote cluster when specific data stream categories are deemed unhealthy at the local cluster. The data source (e.g., producer application) will switch to the remote cluster for only a specific data stream category while other data stream categories are still available and healthy at the local cluster. When the local cluster is deemed healthy again for the switched data stream category, the data source will switch back to the local cluster.

Throughout the failover process, the instances of the consumer application can keep running in the local and remote datacenter clusters. The failover or switch from the local cluster to the remote cluster is completely invisible to the consumer application because the consumer application has multiple instances running on both the remote cluster and local cluster. The CCFF configuration is designed to maintain data integrity for one or more data stream categories (e.g. flows, topics, maps) that are replicated on multiple partitions and/or mirrored between a local cluster and remote cluster.

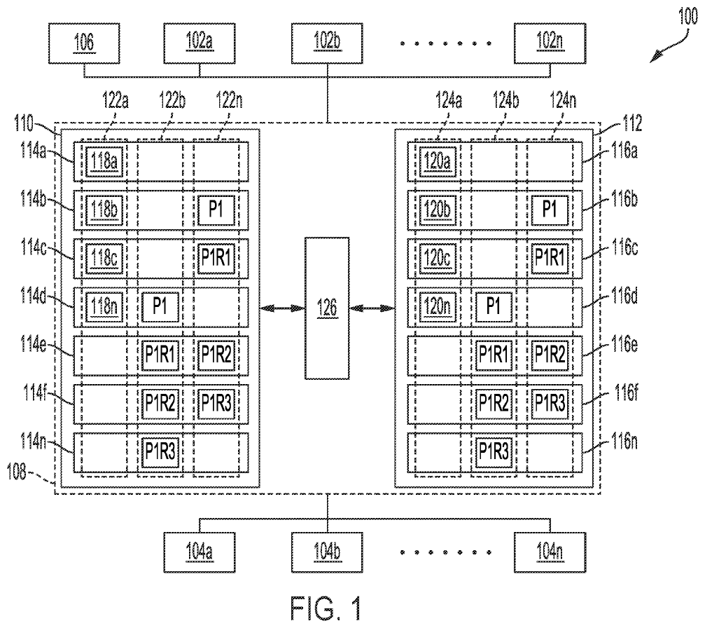

FIG. 1 shows a block diagram of a cross cluster failover framework 100 of a cluster 108, comprising a local datacenter cluster 110 and a remote datacenter cluster 112, and controlled by a cluster manager 106, according to at least one aspect of the present disclosure. In various aspects, the cluster manager 106 is a server or computing system. The cluster 108 is configured to receive one or more data stream categories 122a-n, 124a-n (e.g. topics, maps, etc.) from one or more data sources 102a-n (e.g. producer applications). The data (e.g. messages, records, etc.) are written to or published by the cluster 108, and are immediately accessible by one or more consumer applications 104a-n (e.g. subscriber).

The cluster manager 106 provisions a first connection between one or more data sources 102a-n, and the local cluster 110 or remote cluster 112. In one aspect, the local cluster may be set as the default cluster due to physical proximity and/or lower latency compared to the remote cluster 112. The data source 102a pushes data to the local cluster 110, where the data are associated with a specific data stream category and written (e.g. published) to a node 114a hosting an original data copy (P1) in a partition 118a-n.

FIG. 1 further shows a non-exhaustive example of a local cluster 110, comprising seven nodes 114a-n (e.g. servers, brokers) configured to host original partitions 118a, 120a and replica partitions 118b-n, 120b-n for three data stream categories 112a-n, 124a-n. In the present example, data source 102a pushes data to node 114a, where the local cluster 110 publishes the original copy of the record in partition 118a. In various aspects, partition 118a is designated as the leader partition for data stream category 122a and partitions 118b-n are the follower partitions for 122a. In this example, data stream category 122a has a replication factor of four and follower partitions 118b-d publish in-sync replica (ISR) copies of the original data in replica partitions. The replication factor is configurable by the cluster manager 106 or application (e.g., client library).

Each node 114a-n, 116a-n in the cluster may be configured to host multiple data stream categories 122a-n, 124a-n through the partitioning configuration. For example, node 114b hosts the first ISR copy (P1R1) for data stream category 122a in partition 118b and node 114b also hosts the original copy (P1) for topic 122n. The partitioning configuration increases the data integrity of data stream categories 122a-n, 124a-n and increases the input/output throughput by allowing synchronous reads by applications 104a-104n or synchronous/asynchronous writes by data sources 102a-n.

The cross cluster failover framework relies on a mirror of use cases (e.g., topics) between the local cluster 110 and the remote cluster 112. In various aspects, multiple instances of the consumer application 104a-n are simultaneously connected to the local cluster 110 and the remote cluster 112. Accordingly, replicator 126 is not required to synchronize the datasets between the local cluster 110 and the remote cluster 112. As long as a message is published on one healthy clusters, the consumer applications 104a-n are able to consume the data.

In one aspect, a replicator 126 (e.g., MirrorMaker) may be configured to mirror data between the local cluster 110 and the remote cluster 112. The replicator 126 mirrors data to the local cluster 110 when the data source 102a is connected to the remote cluster 112 and publishes to the remote cluster 112. Similarly, the replicator 126 may mirror data to the remote cluster 112 when the data source 102a is connected to the local cluster 110 and publishes to the local cluster 110. Accordingly, the records in partition 118a of node 114a for data stream category 122a at the local cluster 110 may be published in partition 120a of node 116a for data stream category 124a at the remote cluster 112.

Therefore, once the data records are published to a partition or on either cluster, the data records are immediately available to consumer applications 104a-n (e.g. subscriber). The client application 128 or cluster manager 106 may be comprise a library for configuration parameters of the cross cluster failover framework. In various aspects, these configuration parameters include permissions for the data stream category, minimum number of insync replicas required for each data stream category, replication factor, firewall request parameters for connectivity between clusters and cluster manager 106.

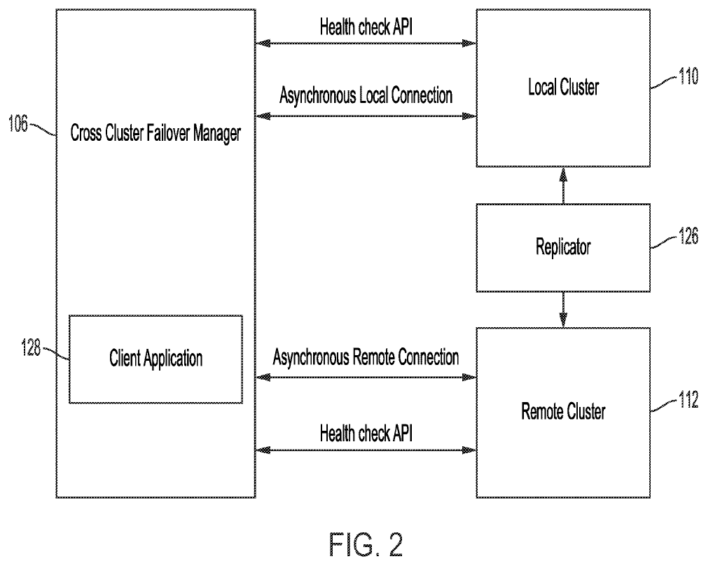

FIG. 2 show a block diagram of the cluster manager 106, configured to continuously or periodically monitor the health of the remote cluster 112 and local cluster 110, according to at least one aspect of the present disclosure. The client application 128 may configure the cluster manager 106 to perform health checks for the remote cluster 112 and local cluster 110 at different intervals. The cluster manager 106 maintains continuous connections to the local cluster 110 and the remote cluster 112 via the health check application program interface to determine the health of each cluster. In one example, if the local cluster 110 is in use, the health check interval for the local cluster 110 may be more frequent than the remote cluster 112. The cluster manager 106 may check the health of each cluster by polling the health at the designated health check interval through an application program interface (API) that designates a specification health check port for each node in the cluster. Accordingly, the cluster manager 106 determines a cluster status as a local health and remote health based on the health of cluster nodes, minimum number of insync replicas required for each data stream, and replication factor for the data stream partitions. In one aspect, the local health and remote health may comprise granular status information of each node in the cluster. In another aspect, the local health and remote health may comprise a binary determination of the health of a data stream in a cluster, based on the pass or fail of a health requirement.

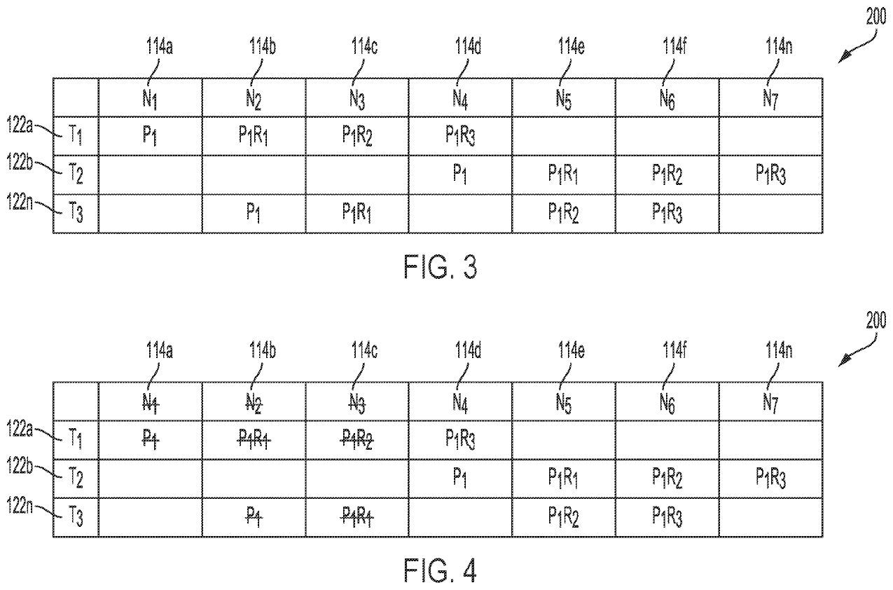

FIG. 3 shows an example cluster configuration 200 for nodes 114a-n, 116a-n, partitions 118a-n, 120a-n, and topics 122a-n, 124a-n, for a datacenter cluster in either the remote cluster 112 or local cluster 110, according to at least one aspect of the present disclosure. Each column is representative of a node 114a-n in a cluster and each row is representative of a data stream category or topic 122a-n that hosts by a plurality of nodes 114a-n. Accordingly, example cluster configuration 200 may be representative of local cluster 110 or remote cluster 112 of FIG. 1. The cluster manager 126 polls each node 14a-n in the cluster to determine the topic 122a-n health, as shown in FIG. 2. Each node 114a-n must respond to the health check message within a predetermined amount of time in order for the cluster manager 106 to determine that the node is healthy, and evaluate the health of each topic 112a-n.

FIG. 4 shows a first example health check response evaluation by a cluster manager 106, for cluster configuration 200, according to at least one aspect of the present disclosure. In this example, Nodes 114a-c failed to response to the health check message within the predetermined amount of time and the cluster manager 106 determined Nodes 114a-c to be down. The health of the cluster is evaluated on a per topic basis, where each topic is required to have a minimum number of ISR active for a given topic. In various aspect, the local cluster 110 and the remote cluster 112 may require different the minimum numbers of ISR, in order for a topic to be healthy. For example, one cluster may require a larger minimum number of ISR to be active in order to maintain a higher degree of data integrity for the one cluster.

In the example for FIG. 4, the minimum number of ISR is 2, and at least 2 nodes that host partitions of insync replicas for a topic must be active. FIG. 4 shows Topic T₁ 122a with one active node and therefore Topic T₁ 122a does have at least 2 ISR active. Node 114d is the only node available for the data source 102 to publish a message in the cluster for this topic 112a. Accordingly, Topic T₁ 122a is determined to be unhealthy. However, Topics T₂ 112b and T₃ 122n, have 2 or more nodes active and are therefore determined to be healthy.

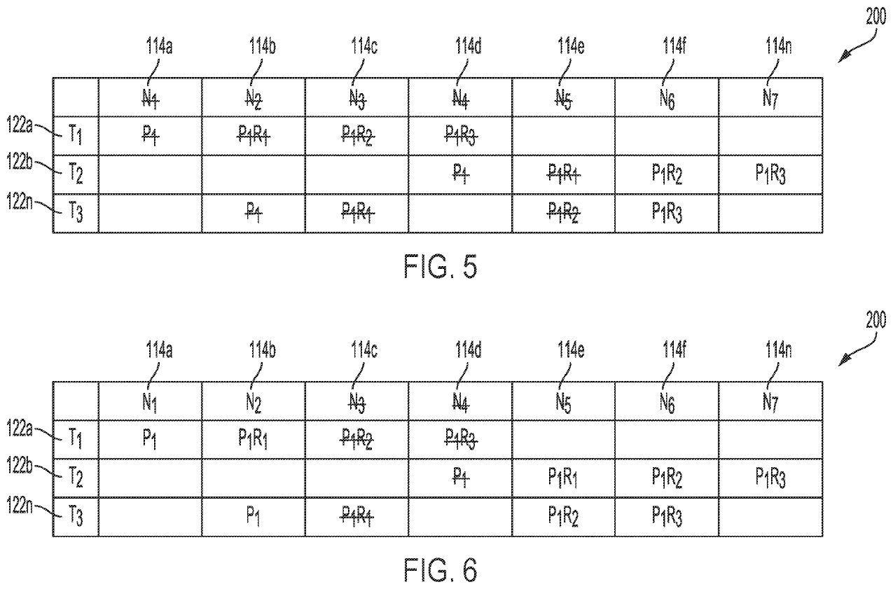

FIG. 5 shows a second example health check response evaluation by a cluster manager 106, for cluster configuration 200, according to at least one aspect of the present disclosure. In this example, the minimum number of ISR is still set to two. However, Nodes 114a-e failed to response to the health check message within the predetermined amount of time and the cluster manager 106 determined Nodes 114a-e to be down. Now Topic T₂ 122b is the only topic in the cluster to be consider healthy, and Topics T₁ 122a and T₃ 122n are considered to be unhealthy. In this example, the failover framework may switch the data source to the other cluster for Topics T₁ 122a and T₃ 122n, while keeping the connection with the current cluster for Topic T₂ 122b.

FIG. 6 shows a third example health check response evaluation by a cluster manager 106, for cluster configuration 200, according to at least one aspect of the present disclosure. In this example, the minimum number of ISR is still set to 2 but the topic partition leader (e.g. original record partition), must also be healthy. Here, Nodes 114b-c failed to response to the health check message within the predetermined amount of time and the cluster manager 106 determined Nodes 114b-c to be down. The cluster manager determines Topics T₁ 122a and T₃ 122n to be healthy and Topic T₂ 122b to be unhealthy. Although Topic T₂ 122b has 3 active ISRs, the leader partition is on node 114c is down, and therefore does not meet the topic health requirement.

After the health check response evaluation, the cluster manager 106 determines whether to initiate the failover process for a specific topic. In one aspect, once the cluster manager 106 determines that the topic at the local cluster 110 is unhealthy, the cluster manager 106 initiates a failover process and switches the data source 102 connection (e.g., synchronous or asynchronous connection) to the remote cluster 112. If the cluster manager 106 determines that the local cluster 110 is healthy again, the cluster manager 106 switches the data source 102 connection back the local cluster 110.

In various aspects, the health check evaluation process may require that a node misses three consecutive health check responses before the cluster manager 106 determines that the node is unhealthy. This evaluation criteria takes into consideration that a node may be temporarily unhealthy for a few seconds for various reasons, such as network connection issues. Once the node misses the first health check response, the allotted response time may be decreased for each subsequent negative health check outcome.

In the event that both the local cluster 110 and remote cluster 112 are both considered unhealthy, the data source 102 is not switched and the cluster manager 106 periodically checks both local 110 and remote 112 clusters. Additionally, the cluster manager 106 may send an error callback message to the client application 128, log an error event, or trigger an alert to the local cluster 110 and the remote cluster 112. When a first cluster is determined to be healthy again, the data source 102 switches or stays on the healthy cluster and starts publishing to the healthy cluster.

In one aspect, the failover process may be initiated based on an “all or nothing” switching scheme. In the “all or nothing” switching scheme, the client application 128 identifies a high priority topic or a list of high priority topics. The health of the clusters are checked for high priority topics and a failover process is initiated if any of the high priority topics are unhealthy in the current cluster 106 and all of the high priority topics are healthy in the other cluster. Accordingly, the cluster manager 106 may initiate a failover for all topics for the data source or none of the topics.

In another example of the “all or nothing” switching scheme, a data source 102a is asynchronously connected to the local cluster 110 via a first connection and publishes messages for Topics T₁, T₂, and T₃ to the local cluster 110. In this example, Topics T₁, T₂, and T₃ correspond to the data source 102a. The client application 128 may identify Topic T₁ as a critical data stream category such as a transactional data pipeline, whereas Topics T₂ and T₃ are identified as less critical data stream categories like reporting and logging pipelines. Due to the criticality of T₁, the client application 128 may designate a failover priority at the topic level for T₁. Thus, if anything happens to the health of Topic T₁ at the local cluster 110, the cluster manager 106 immediately switches to the remote cluster 112 by switching all three Topics T₁, T₂, and T₃ all three for data source 102a. However, if Topics T₂ and T₃ are unhealthy and T₁ is healthy, then the current cluster can continue to operate for T₁ without impacting critical data for the client application 128. In a system with a replicator 126, the data for Topics T₂ and T₃, which is not required, can be acquired in a synchronous manner from the remote cluster 112. Accordingly, the applications are managed in a manner such the application is not impacted by failover switching or down partitions.

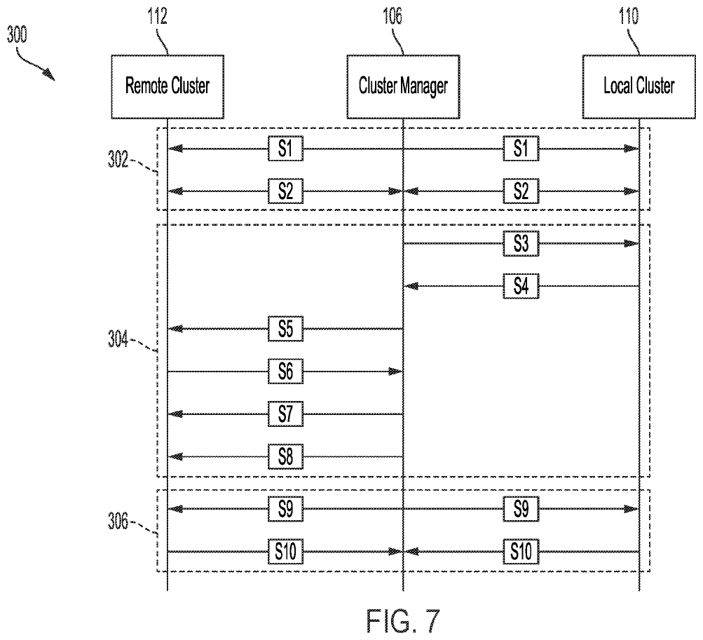

FIG. 7 is a flow diagram of a failover process 300, according to the cross cluster failover framework, from the local cluster 110 to the remote cluster 112, according to at least one aspect of the present disclosure. At step 1, the cluster manager 106 polls 302 the health of each node 114a-n at the local cluster 110 and each node 116a-n at the remote cluster 112. The cluster manager 106 receives health check response messages from the nodes 114a-n, 116a-n and determines a Topic T₁ at the local cluster 110 is unhealthy and the Topic T₁ at the remote cluster 112 is healthy. The cluster manager 106 initiates 304 a failover process from the local cluster 110 to the remote cluster 112 for the first Topic T₁ only. As shown in FIG. 4, Topics T₂ and T₃ are still healthy and operating on the local cluster 110, and therefore only Topic T₁ is switched. As part of the failover process, the cluster manager 106 may optionally begin to buffer unpublished data records and/or new message from the data source 102. At Step 3, the cluster manager 106 closes the asynchronous data connections between the data source 102 and the local cluster 110. At Step 4, the cluster manager 106 receives confirmation that all asynchronous data connections between the data source 102 and the local cluster 110 are closed. In alternate aspect, the asynchronous data connections may be active at both local cluster 110 and the remote cluster without the need to close the connections. At Step 5, the cluster manager 106 creates an instance for the data source 102 of Topic T₁ at the remote cluster. At Step 6, the cluster manager 106 receives confirmation that the instance for the data source 102 at the remote cluster 112 was created (e.g., acknowledgement (ACK) message). At Step 7, the cluster manager 106 optionally flushes the buffers to the remote cluster 112, if buffering is configured by the client application 128. Once the data in the buffers are published to the remote cluster 112, the buffers can be purged for future use. At Step 8, the cluster manager 106 continues to publish data to the remote cluster 112. The cluster manager 106 continues to poll 306 the health of each node 114a-n at the local cluster 110 and the remote cluster 112. If the cluster manager 106 determines that the remote cluster 112 is healthy and the local cluster 110 is healthy again, the cluster manager 106 will initiate a failover to switch back to the local cluster 110. The cluster manager 106 will initiate the switchback even when the remote cluster is healthy.

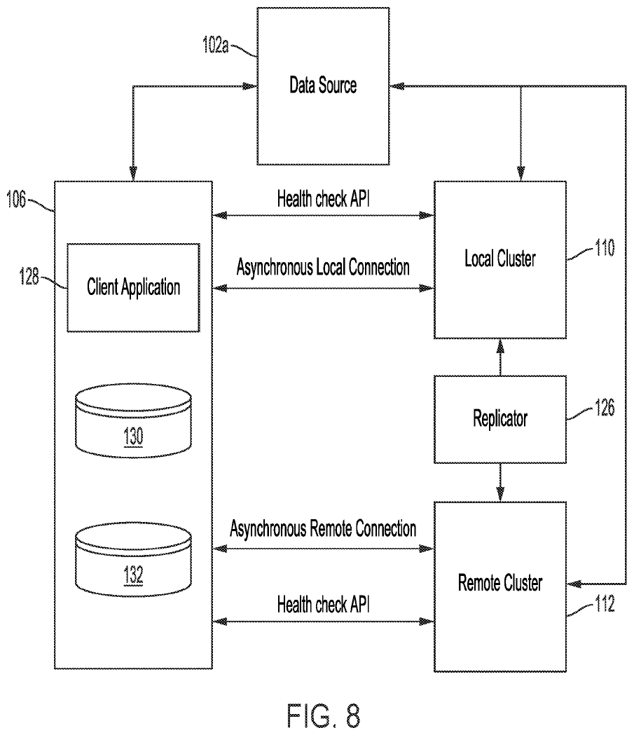

FIG. 8 is a block diagram of a cluster manager 106 configured to buffer data from a data source, according to at least one aspect of the present disclosure. The data sources 102a continue to push data (e.g. messages) to the cluster 108 after a failover is initiated. The cluster manager 106 may comprise a plurality of buffers to temporarily store messages until the failover is completed. In one aspect, the cluster manager 106 comprises a data source switching buffer 130 and an unpublished message buffer 132. The data source switching buffer 130 stores messages received by the data source 102a when the data source 102a tries to publish messages after the failover is initiated, but before the failover is completed. The unpublished message buffer 132 stores messages when the data source 102a tries to publish messages but is unsuccessful because the local cluster 110 is unhealthy and the failover has not been initiated. Accordingly, the message buffers 130, 132 are configured to store messages received but unpublished to ensure that there is zero message loss during the failover process. Once the failover process is completed, the buffers are flushed to the destination cluster of the failover process.

In various aspects, the buffers 130, 132 may comprise a configurable size limit to prevent buffer overflow. Once the buffer limit is reached, messages may be routed to a secondary buffer or storage until the failover is completed.

In one aspect, it may be desirable for unpublished messages to fail-fast and not use the buffers 130, 132. Accordingly, the client application 128 may configure the cluster manager 106 to set the buffer limit size to zero and receive a fast-fail notification. All publish requests from the time that the local cluster 110 is unhealthy until the failover is completed will fail, after internal retries by the cluster manager. For a configuration without buffering, the client application 128 must be configured to initiate retry publish requests after the failover is completed.

In various aspects, the cluster manager 106 may test the cluster failover functionality without actually bringing down a cluster by utilizing a toggle integration feature. The cross cluster failover framework may be integrated with a toggle feature that allows for cluster testing and dynamic control of the cluster configuration. The testing function of toggle integration allows for periodic checks of the failover framework to verify that the system is performing as expected. The dynamic control function of toggle integration allows the cluster manager 106 to disable the functionality of the failover framework without impacting or rolling back the release versions of client application 128, dynamically. The toggle integration feature can disable the failover framework functionality and restore default settings of the cluster computing platform (e.g., Kafka, Hazelcast, etc.).

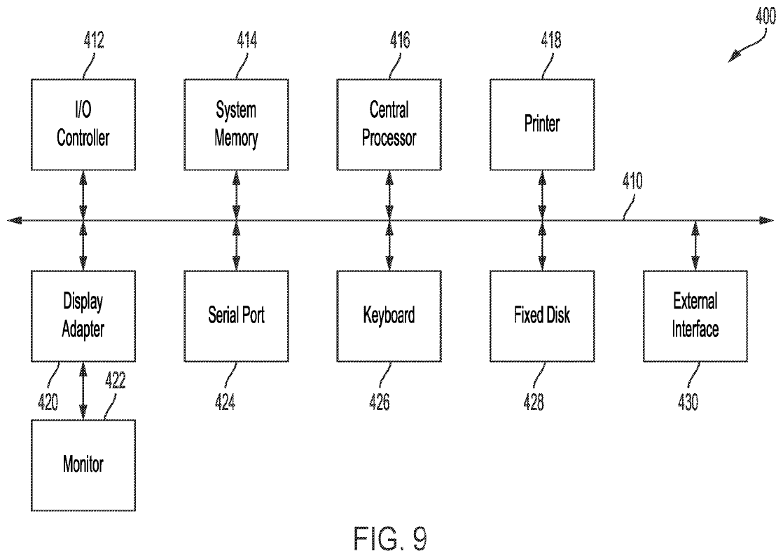

FIG. 9 is a block diagram of a computer apparatus 400 with data processing subsystems or components, according to at least one aspect of the present disclosure. The subsystems shown in FIG. 9 are interconnected via a system bus 410. Additional subsystems such as a printer 418, keyboard 426, fixed disk 428 (or other memory comprising computer readable media), monitor 422, which is coupled to a display adapter 420, and others are shown. Peripherals and input/output (I/O) devices, which couple to an I/O controller 412 (which can be a processor or other suitable controller), can be connected to the computer system by any number of means known in the art, such as a serial port 424. For example, the serial port 424 or external interface 430 can be used to connect the computer apparatus to a wide area network such as the Internet, a mouse input device, or a scanner. The interconnection via system bus allows the central processor 416 to communicate with each subsystem and to control the execution of instructions from system memory 414 or the fixed disk 428, as well as the exchange of information between subsystems. The system memory 414 and/or the fixed disk 428 may embody a computer readable medium.

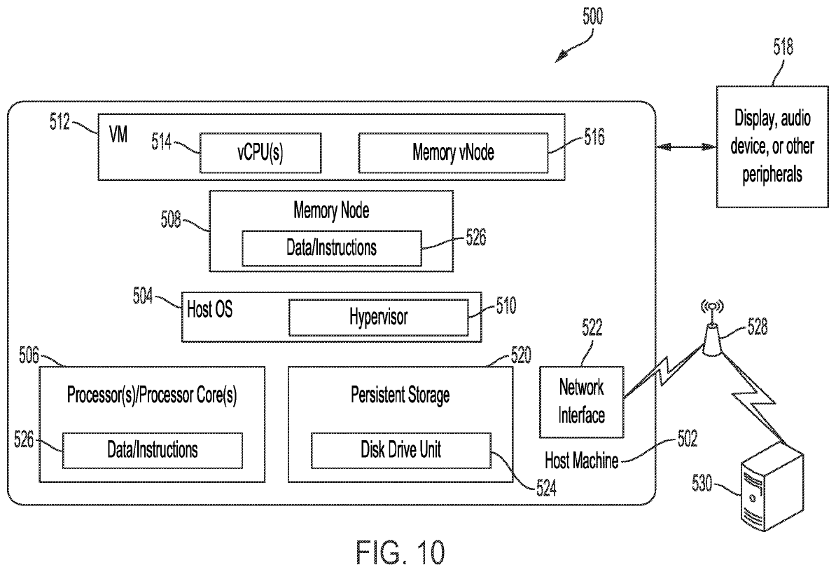

FIG. 10 is a diagrammatic representation of an example system 500 that includes a host machine 502 within which a set of instructions to perform any one or more of the methodologies discussed herein may be executed, according to at least one aspect of the present disclosure. In various aspects, the host machine 502 operates as a standalone device or may be connected (e.g., networked) to other machines. In a networked deployment, the host machine 502 may operate in the capacity of a server or a client machine in a server-client network environment, or as a peer machine in a peer-to-peer (or distributed) network environment. The host machine 502 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 500 includes the host machine 502, running a host operating system (OS) 504 on a processor or multiple processor(s)/processor core(s) 506 (e.g., a central processing unit (CPU), a graphics processing unit (GPU), or both), and various memory nodes 508. The host OS 504 may include a hypervisor 510 which is able to control the functions and/or communicate with a virtual machine (“VM”) 512 running on machine readable media. The VM 512 also may include a virtual CPU or vCPU 514. The memory nodes 508 may be linked or pinned to virtual memory nodes or vNodes 516. When the memory node 508 is linked or pinned to a corresponding vNode 516, then data may be mapped directly from the memory nodes 508 to their corresponding vNodes 516.

All the various components shown in host machine 502 may be connected with and to each other, or communicate to each other via a bus (not shown) or via other coupling or communication channels or mechanisms. The host machine 502 may further include a video display, audio device or other peripherals 518 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 520 (also referred to as disk drive unit), and a network interface device 522. The host machine 502 may further include a data encryption module (not shown) to encrypt data. The components provided in the host machine 502 are those typically found in computer systems that may be suitable for use with aspects of the present disclosure and are intended to represent a broad category of such computer components that are known in the art. Thus, the system 500 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 524 also may be a Solid-state Drive (SSD), a hard disk drive (HDD) or other includes a computer or machine-readable medium on which is stored one or more sets of instructions and data structures (e.g., data/instructions 526) embodying or utilizing any one or more of the methodologies or functions described herein. The data/instructions 526 also may reside, completely or at least partially, within the main memory node 508 and/or within the processor(s) 506 during execution thereof by the host machine 502. The data/instructions 526 may further be transmitted or received over a network 528 via the network interface device 522 utilizing any one of several well-known transfer protocols (e.g., Hyper Text Transfer Protocol (HTTP)).

The processor(s) 506 and memory nodes 508 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 502 and that causes the host machine 502 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 530 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 502, with each server 530 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Example 1. A distributed data processing system comprising: a cluster management server configured to communicate with a cluster system comprising a first server cluster and a second server cluster in geographically different regions, the cluster management server comprising a processor and a memory coupled to the processor, the memory storing thereon machine executable instructions that when executed cause the processor to: determine an initial health status of the first server cluster; establish a first push connection between a data source and the first server cluster based on a determination that the first server cluster is healthy; monitor data being transmitted from the data source to the first server cluster, wherein the first server cluster publishes the data to a plurality of data stream categories corresponding to the data; determine a first cluster health status of the first server cluster for each of the plurality of data stream categories associated with the data source; determine a second cluster health status of the second server cluster for each of the plurality of data stream categories associated with the data source; determine the first server cluster is unhealthy for a first data stream category of the plurality of data stream categories associated with the data source; initiate a failover associated with the first data stream category for the data source, wherein the failover cause the processor to: establish a second push connection to the second server cluster based on a determination that the second server cluster is healthy for the first data stream category associated with the data source; and switch the data source from transmitting to the first server cluster to the second server cluster based on the determination that the first server cluster is unhealthy for the data source and the determination that the second server cluster is healthy for the data source.

Example 2. The distributed data processing system of Example 1, wherein the processor is further configured to: determine the first cluster health status for each of the plurality of data stream categories associated with the data source, wherein the first cluster health status for the first data stream category is healthy; determine the second cluster health status for each of the plurality of data stream categories associated with the data source, wherein the second cluster health status for the first data stream category is healthy; initiate the failover associated with the first data stream category of the data source, wherein the failover cause the processor to: re-establish the first push connection to the first server cluster based on a determination that the second server cluster is healthy for the first data stream category; and switch the data source back to transmitting to the first server cluster from the second server cluster based on the determination that the first server cluster is unhealthy for the first data stream category.

Example 3. The distributed data processing system of Examples 1 and 2, wherein the processor is further configured to: determine the first cluster health status for each of the plurality of data stream categories associated with the data source, wherein the first cluster health status for the first data stream category is unhealthy; determine the second cluster health status for each of the plurality of data stream categories associated with the data source, wherein the second cluster health status for the first data stream category is unhealthy; maintain the second push connection between the data source and the second server cluster and wait for a subsequent second cluster health status of the second server cluster and a subsequent first cluster health status of the first server cluster; and determine to continue transmitting data to the second server cluster or initiate the failover to the first server cluster, based on the subsequent second cluster health status of the second server cluster and the subsequent first cluster health status of the first server cluster.

Example 4. The distributed data processing system of Examples 1-3, wherein each of the plurality of data stream categories is hosted by a plurality of nodes, wherein a first node of the plurality of nodes comprises a leader partition for an original copy of the data and a second node of the plurality of nodes comprises a follower partition for a first replica partition of the data.

Example 5. The distributed data processing system of Example 4, wherein the cluster management server determines a node health status for each of the plurality of nodes, wherein the node health status is determined by sending a health check poll to each of the plurality of nodes, and wherein an active node responds to the health check poll within a predetermined period of time.

Example 6. The distributed data processing system of Example 5, wherein the cluster management server determines a down node based on a failure to respond to the health check poll within a predetermined period of time for three consecutive health check polls.

Example 7. The distributed data processing system of Example 6, wherein the predetermined period of time to respond to the health check poll decreases each time a health response fails to meet the predetermined period of time to respond, and wherein the predetermined period of time to respond resumes a default response for the active node.

Example 8. The distributed data processing system of Examples 4-7, wherein the second cluster health status and the first cluster health status are determined based on a minimum number of insync replica partitions that are available at a number of active nodes for each of the plurality of data stream categories.

Example 9. The distributed data processing system of Example 8, wherein the processor is further configured to: determine the number of active nodes from the plurality of nodes for each of the plurality of data stream categories, wherein the number of active nodes for each of the plurality of data stream categories represent a number of insync replicas available for each of the plurality of data stream categories; and compare the number of insync replicas available for each of the plurality of data streams to a minimum number of insync replica partitions.

Example 10. The distributed data processing system of Example 9, wherein at least a second data stream category is determined to be unhealthy and at least a third data stream category is determined to be healthy.

Example 11. The distributed data processing system of Example 10, wherein the second data stream category is determined to be unhealthy based on failing to meet the minimum number of insync replicas; and wherein the third data stream category is determined to be healthy based on meeting the minimum number of insync replicas.

Example 12. The distributed data processing system of Example 10, wherein the second data stream category is determined to be unhealthy based on failing to meet the minimum number of insync replicas or the leader partition for the first data stream category is down; and wherein the third data stream category is determined to be healthy based on meeting the minimum number of insync replicas, and at least one of the insync replicas is the leader partition for the second data stream category.

Example 13. The distributed data processing system of Examples 1-12, wherein the cluster management server comprises a failover switching buffer configured to store data after the failover is initiated but before the failover is completed, and wherein the data cannot publish to the cluster system until the failover between the first server cluster and second server cluster is completed.

Example 14. The distributed data processing system of Examples 1-13, wherein the cluster management server comprises an unpublished data buffer configured to store data that is unpublished by the cluster system before a failover is initiated, and wherein the data fails to publish to the first server cluster or second server cluster.

Example 15. The distributed data processing system of Examples 4-14, wherein the cluster management server is configured to initiation a test failover from the first server cluster to the second server cluster, wherein the test failover does not take down any of plurality of nodes in the cluster system.

Example 16. The distributed data processing system of Example 1, wherein at least one of the plurality of data stream categories is identified as high priority data stream categories.

Example 17. The distributed data processing system of Example 16, wherein the processor is further configured to: initiate a failover associated for all of the plurality of data stream categories based on determining that the first server cluster is unhealthy for any of the data stream categories for the data source and determining that the second server cluster is healthy for all of the data stream categories for the data source.

Example 18. A method for cross cluster failover management, the method comprising: determining, by a cluster management server, an initial first cluster health status of a first server cluster and an initial second cluster health status of a second server cluster; establishing, by the cluster management server, a push connection between a data source and the first server cluster based on determining that the initial first cluster health status of the first server cluster is healthy; monitoring, by the cluster management server, data being transmitted from the data source to the first server cluster, wherein the first server cluster publishes the data to a plurality of data stream categories corresponding to the data; determining, by the cluster management server, a first cluster health status of the first server cluster for each of the plurality of data stream categories associated with the data source; determining, by the cluster management server, a second cluster health status of the second server cluster for each of the plurality of data stream categories associated with the data source; determining, by the cluster management server, the first server cluster is unhealthy for a first data stream of the plurality of data stream categories associated with the data source; initiating, by the cluster management server, a failover associated with the first data stream category for the data source, wherein the failover is further comprising: establishing, by the cluster management server, a second push connection to the second server cluster based on a determination that the second server cluster is healthy for the first data stream category associated with the data source; switching, by the cluster management server, the data source from transmitting to the first server cluster to the second server cluster based on the determination that the first server cluster is unhealthy for the data source and the determination that the second server cluster is healthy for the data source; and maintaining, by the cluster management server, a first pull data connection between the first server cluster and a first application instance, and a second pull data connection between the second server cluster and a second application instance.

Example 19. The method of Example 18, further comprising: determining, by the cluster management server, the first cluster health status for each of the plurality of data stream categories associated with the data source, wherein the first cluster health status for the first data stream category is healthy; determining, by the cluster management server, the second cluster health status for each of the plurality of data stream categories associated with the data source, wherein the second cluster health status for the first data stream category is healthy; initiating, by the cluster management server, the failover associated with the first data stream category of the data source, wherein the failover is further comprising: re-establishing, by the cluster management server, a connection to the first server cluster based on a determination that the second server cluster is healthy for the first data stream category; switching, by the cluster management server, the data source back to transmitting to the first server cluster from the second server cluster based on the determination that the first server cluster is unhealthy for the first data stream category; and maintaining, by the cluster management server, the first pull data connection between the first server cluster and a consumer application, and the second pull data connection between the second server cluster and the consumer application.

Example 20. The method of Examples 18 and 19, further comprising: determining, by the cluster management server, the first cluster health status for each of the plurality of data stream categories associated with the data source, wherein the first cluster health status for the first data stream category is unhealthy; determining, by the cluster management server, the second cluster health status for each of the plurality of data stream categories associated with the data source, wherein the second cluster health status for the first data stream category is unhealthy; maintaining, by the cluster management server, the second push connection between the data source and the second server cluster and wait for a subsequent second cluster health status of the second server cluster and a subsequent first cluster health status of the first server cluster; and determining, by the cluster management server, to continue transmitting data to the second server cluster or initiate the failover to the first server cluster, based on the subsequent second cluster health status of the second server cluster and the subsequent first cluster health status of the first server cluster.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A distributed data processing system comprising:
a cluster management server configured to communicate with a cluster system comprising a first server cluster and a second server cluster in geographically different regions, the cluster management server comprising a processor and a memory coupled to the processor, the memory storing thereon machine executable instructions that when executed cause the processor to:
determine an initial health status of the first server cluster;
establish a first push connection between a data source and the first server cluster based on a determination that the first server cluster is healthy;
monitor data being transmitted from the data source to the first server cluster, wherein the first server cluster publishes the data to a plurality of data stream categories corresponding to the data;
determine a first cluster health status of the first server cluster for each of the plurality of data stream categories associated with the data source;
determine a second cluster health status of the second server cluster for each of the plurality of data stream categories associated with the data source;
determine the first server cluster is unhealthy for a first data stream category of the plurality of data stream categories associated with the data source;
initiate a failover associated with the first data stream category for the data source, wherein the failover cause the processor to:
establish a second push connection to the second server cluster based on a determination that the second server cluster is healthy for the first data stream category associated with the data source; and
switch the data source from transmitting to the first server cluster to the second server cluster based on the determination that the first server cluster is unhealthy for the data source and the determination that the second server cluster is healthy for the data source.

2. The distributed data processing system of claim 1, wherein the processor is further configured to:
determine the first cluster health status for each of the plurality of data stream categories associated with the data source, wherein the first cluster health status for the first data stream category is healthy;
determine the second cluster health status for each of the plurality of data stream categories associated with the data source, wherein the second cluster health status for the first data stream category is healthy;
initiate the failover associated with the first data stream category of the data source, wherein the failover cause the processor to:
re-establish the first push connection to the first server cluster based on a determination that the second server cluster is healthy for the first data stream category; and
switch the data source back to transmitting to the first server cluster from the second server cluster based on the determination that the first server cluster is unhealthy for the first data stream category.

3. The distributed data processing system of claim 1, wherein the processor is further configured to:
determine the first cluster health status for each of the plurality of data stream categories associated with the data source, wherein the first cluster health status for the first data stream category is unhealthy;
determine the second cluster health status for each of the plurality of data stream categories associated with the data source, wherein the second cluster health status for the first data stream category is unhealthy;
maintain the second push connection between the data source and the second server cluster and wait for a subsequent second cluster health status of the second server cluster and a subsequent first cluster health status of the first server cluster; and
determine to continue transmitting data to the second server cluster or initiate the failover to the first server cluster, based on the subsequent second cluster health status of the second server cluster and the subsequent first cluster health status of the first server cluster.

4. The distributed data processing system of claim 1, wherein each of the plurality of data stream categories is hosted by a plurality of nodes, wherein a first node of the plurality of nodes comprises a leader partition for an original copy of the data and a second node of the plurality of nodes comprises a follower partition for a first replica partition of the data.

5. The distributed data processing system of claim 4, wherein the cluster management server determines a node health status for each of the plurality of nodes, wherein the node health status is determined by sending a health check poll to each of the plurality of nodes, and wherein an active node responds to the health check poll within a predetermined period of time.

6. The distributed data processing system of claim 5, wherein the cluster management server determines a down node based on a failure to respond to the health check poll within a predetermined period of time for three consecutive health check polls.

7. The distributed data processing system of claim 6, wherein the predetermined period of time to respond to the health check poll decreases each time a health response fails to meet the predetermined period of time to respond, and wherein the predetermined period of time to respond resumes a default response for the active node.

8. The distributed data processing system of claim 4, wherein the second cluster health status and the first cluster health status are determined based on a minimum number of insync replica partitions that are available at a number of active nodes for each of the plurality of data stream categories.

9. The distributed data processing system of claim 8, wherein the processor is further configured to:
determine the number of active nodes from the plurality of nodes for each of the plurality of data stream categories, wherein the number of active nodes for each of the plurality of data stream categories represent a number of insync replicas available for each of the plurality of data stream categories; and
compare the number of insync replicas available for each of the plurality of data stream categories to a minimum number of insync replica partitions.

10. The distributed data processing system of claim 9, wherein at least a second data stream category is determined to be unhealthy and at least a third data stream category is determined to be healthy.

11. The distributed data processing system of claim 10, wherein the second data stream category is determined to be unhealthy based on failing to meet the minimum number of insync replicas; and wherein the third data stream category is determined to be healthy based on meeting the minimum number of insync replicas.

12. The distributed data processing system of claim 10, wherein the second data stream category is determined to be unhealthy based on failing to meet the minimum number of insync replicas or the leader partition for the first data stream category is down; and wherein the third data stream category is determined to be healthy based on meeting the minimum number of insync replicas, and at least one of the insync replicas is the leader partition for the second data stream category.

13. The distributed data processing system of claim 1, wherein the cluster management server comprises a failover switching buffer configured to store data after the failover is initiated but before the failover is completed, and wherein the data cannot publish to the cluster system until the failover between the first server cluster and second server cluster is completed.

14. The distributed data processing system of claim 1, wherein the cluster management server comprises an unpublished data buffer configured to store data that is unpublished by the cluster system before a failover is initiated, and wherein the data fails to publish to the first server cluster or second server cluster.

15. The distributed data processing system of claim 4, wherein the cluster management server is configured to initiation a test failover from the first server cluster to the second server cluster, wherein the test failover does not take down any of plurality of nodes in the cluster system.

16. The distributed data processing system of claim 1, wherein at least one of the plurality of data stream categories is identified as high priority data stream categories.

17. The distributed data processing system of claim 16, wherein the processor is further configured to:
initiate a failover associated for all of the plurality of data stream categories based on determining that the first server cluster is unhealthy for any of the data stream categories for the data source and determining that the second server cluster is healthy for all of the data stream categories for the data source.

18. A method for cross cluster failover management, the method comprising:
determining, by a cluster management server, an initial first cluster health status of a first server cluster and an initial second cluster health status of a second server cluster;
establishing, by the cluster management server, a first push connection between a data source and the first server cluster based on determining that the initial first cluster health status of the first server cluster is healthy;
monitoring, by the cluster management server, data being transmitted from the data source to the first server cluster, wherein the first server cluster publishes the data to a plurality of data stream categories corresponding to the data;
determining, by the cluster management server, a first cluster health status of the first server cluster for each of the plurality of data stream categories associated with the data source;
determining, by the cluster management server, a second cluster health status of the second server cluster for each of the plurality of data stream categories associated with the data source;
determining, by the cluster management server, the first server cluster is unhealthy for a first data stream category of the plurality of data stream categories associated with the data source;
initiating, by the cluster management server, a failover associated with the first data stream category for the data source, wherein the failover is further comprising:
establishing, by the cluster management server, a second push connection to the second server cluster based on a determination that the second server cluster is healthy for the first data stream category associated with the data source;
switching, by the cluster management server, the data source from transmitting to the first server cluster to the second server cluster based on the determination that the first server cluster is unhealthy for the data source and the determination that the second server cluster is healthy for the data source; and
maintaining, by the cluster management server, a first pull data connection between the first server cluster and a first application instance, and a second pull data connection between the second server cluster and a second application instance.

19. The method of claim 18, further comprising:
determining, by the cluster management server, the first cluster health status for each of the plurality of data stream categories associated with the data source, wherein the first cluster health status for the first data stream category is healthy;
determining, by the cluster management server, the second cluster health status for each of the plurality of data stream categories associated with the data source, wherein the second cluster health status for the first data stream category is healthy;
initiating, by the cluster management server, the failover associated with the first data stream category of the data source, wherein the failover is further comprising:
re-establishing, by the cluster management server, the first push connection to the first server cluster based on a determination that the second server cluster is healthy for the first data stream category;
switching, by the cluster management server, the data source back to transmitting to the first server cluster from the second server cluster based on the determination that the first server cluster is unhealthy for the first data stream category; and
maintaining, by the cluster management server, the first pull data connection between the first server cluster and the first application instance, and the second pull data connection between the second server cluster and the second application instance.

20. The method of claim 18, further comprising:
determining, by the cluster management server, the first cluster health status for each of the plurality of data stream categories associated with the data source, wherein the first cluster health status for the first data stream category is unhealthy;
determining, by the cluster management server, the second cluster health status for each of the plurality of data stream categories associated with the data source, wherein the second cluster health status for the first data stream category is unhealthy;
maintaining, by the cluster management server, the second push connection between the data source and the second server cluster and wait for a subsequent second cluster health status of the second server cluster and a subsequent first cluster health status of the first server cluster; and
determining, by the cluster management server, to continue transmitting data to the second server cluster or initiate the failover to the first server cluster, based on the subsequent second cluster health status of the second server cluster and the subsequent first cluster health status of the first server cluster.
